(19) United States
(12) Patent Application Publication
(10) Pub. No.: US 2011/0035336 A1
(43) Pub. Date: Feb. 10, 2011

(54) RATING CHANGE FOR A PREPAID SESSION BASED ON MOVEMENT OF A MOBILE DEVICE

(76) Inventors: Yigang Cai, Naperville, IL (US); Xiangyang Li, Beijing (CN)

Correspondence Address: DUFT BORNSEN & FISHMAN, LLP, 1526 SPRUCE STREET, SUITE 302, BOULDER, CO, 80302, US

(21) Appl. No.: 12/988,136

(22) PCT Filed: May 1, 2008
(86) PCT No.: PCT/US08/62264

§ 371 Date: Oct. 15, 2010

(51) Int. Cl. G06F 17/00

(52) U.S. Cl. 705/400

(57) ABSTRACT

Communication networks and methods are disclosed for dynamically changing the rating for a prepaid session based on movement of a mobile device. During a session involving a mobile device, the communication network monitors location information for the mobile device to determine if the mobile device moves from the first zone to a second zone (i.e., a home zone to a non-home zone). Responsive to a determination that the mobile device has moved zones, the communication network identifies updated location information for the mobile device. The communication network then processes the updated location information for the mobile device to determine an updated rating the session, and applies the updated rating for prepaid charging for the session.

### BACKGROUND OF THE INVENTION

1. Field of the Invention

The invention is related to the field of charging in communication networks, and in particular, to changing the rating applied for a prepaid session based on movement of a mobile device, such as moving from a home zone to a non-home zone and vice-versa.

2. Statement of the Problem

Service providers typically provide numerous voice and/or data services to subscribers using one or more wireline and/or wireless communication networks. Exemplary services include cellular telephony, access to the Internet, gaming, broadcasting or multicasting of audio, video, and multimedia programming, etc. Mobile devices, such as cell phones, personal data assistants, smart phones, pagers, text messaging devices, global positioning system (GPS) devices, network interface cards, notebook computers, and desktop computers, may access the services provided by the communication networks over an air interface with one or more base stations. Communication between the mobile devices and base stations are governed by various standards and/or protocols, such as the standards and protocols defined by the 3rd Generation Partnership Project (3GPP, 3GPP2).

The service providers use prepaid charging functions to keep track of the charges incurred by mobile devices for using the various services provided by the service provider. Prepaid charging is generally defined as a charging mechanism where charging information can affect, in real-time, the service rendered, and therefore a direct interaction of the charging mechanism with session/service control is needed. According to present prepaid mechanisms, the rating for a session (or call) is determined during set up of the session. For instance, if a mobile device initiates a prepaid call, then a prepaid charging function receives a charging request message from the core network before the call is authorized. The charging request message includes location information for the mobile device, along with other charging information, such as the calling party number, the called party number, the class of service for the calling party, etc. The prepaid charging function then determines a rating for the call based on this and other charging information.

When the rating is determined, the prepaid charging function grants a quota of service units based on the rating and the account balance of the calling party. The quota of service units may be an allotment of time, an allotment of monetary units, etc. The prepaid charging function then transmits the granted quota to a budget control system in the core network. In a legacy core network, the budget control system may be implemented in a Service Control Point (SCP), a Mobile Switching Center (MSC), etc. In an IMS core network, the budget control system may be implemented in a Charging Trigger Function (CTF) of a network element, such as an IMS gateway, an application server, etc.

One problem with present prepaid charging mechanisms is that the rating for the session remains the same throughout the duration of the session. The rating is determined upon initiation of the session, and remains unchanged throughout the duration of the session. During an active session, a mobile device may move to a location that would be rated differently had the session been initiated from this location. For example, service providers typically define multiple zones within their network that are charged at different rates. A subscriber is assigned a “home” zone, which typically has a lower rate for the subscriber than the non-home zones. During an active session, a mobile device may move from a home zone to a non-home zone, or vice-versa. Unfortunately, present prepaid charging mechanisms use a single rating throughout the session, and are not able to adjust to location changes of a mobile device.

### SUMMARY OF THE SOLUTION

Embodiments of the invention solve the above and other related problems by dynamically changing the rating during a session based on the location of a mobile device. As with present prepaid charging mechanisms, a rating is initially determined upon set up of the session for prepaid charging. According to the embodiments described herein, during the session, the location of the mobile device is monitored to determine if the mobile device moves from one zone to another zone (i.e., a home zone to a non-home zone, or vice-versa). If the mobile device moves zones, then a new rating is determined for the session based on the location of the mobile device. The new rating is then applied for prepaid charging for the session in place of the initial rating. This process continues during the duration of the session. Thus, the rating for the session may dynamically change based on the location of the mobile device so that the session is charged more accurately. The service provider may advantageously realize higher revenues by applying a higher rate when the mobile device moves into a zone defined as having a higher rating. Also, the subscriber may save money when a lower rate is applied when the mobile device moves into a zone defined as having a lower rating.

One embodiment of the invention comprises a communication network operable to provide dynamic rating changes based on movement of a mobile device. The communication network includes a prepaid charging function operable to receive location information for a mobile device located in a first zone, to process the location information to determine a rating for a session involving the mobile device, and to apply the rating for prepaid charging for the session. During the session, a zone determination system in the communication network is operable to monitor the location information for the mobile device to determine if the mobile device moves from the first zone to a second zone (i.e., a home zone to a non-home zone). Responsive to a determination that the mobile device has moved from the first zone to the second zone, the zone determination system is operable to identify updated location information for the mobile device, and to transmit the update location information to the prepaid charging function. The prepaid charging function is further operable to process the updated location information for the mobile device to determine an updated rating the session, and to apply the updated rating for prepaid charging for the session. The prepaid charging function may be further operable to transmit a notification to the mobile device indicating that the updated rating will be applied to the session.

Before applying the updated rating for the session, the prepaid charging function may consider one or more factors. For instance, one factor may be whether the mobile device moves from a non-home zone to a home zone, or moves from a home zone to a non-home zone. Another factor may be the time that the mobile device is in the second zone. Another factor may be whether or not the second zone is a boundary zone to the first zone. The prepaid charging function may consider multiple other factors when determining which rating to apply for a session.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 illustrates a particular area segmented into zones in an exemplary embodiment of the invention.

FIG. 3 is a flow chart illustrating a method of performing prepaid charging in an exemplary embodiment of the invention.

FIG. 4 is a flow chart illustrating a method of performing prepaid charging in an exemplary embodiment of the invention.

FIG. 5 illustrates cells within two zones in an exemplary embodiment of the invention.

### DETAILED DESCRIPTION OF THE INVENTION

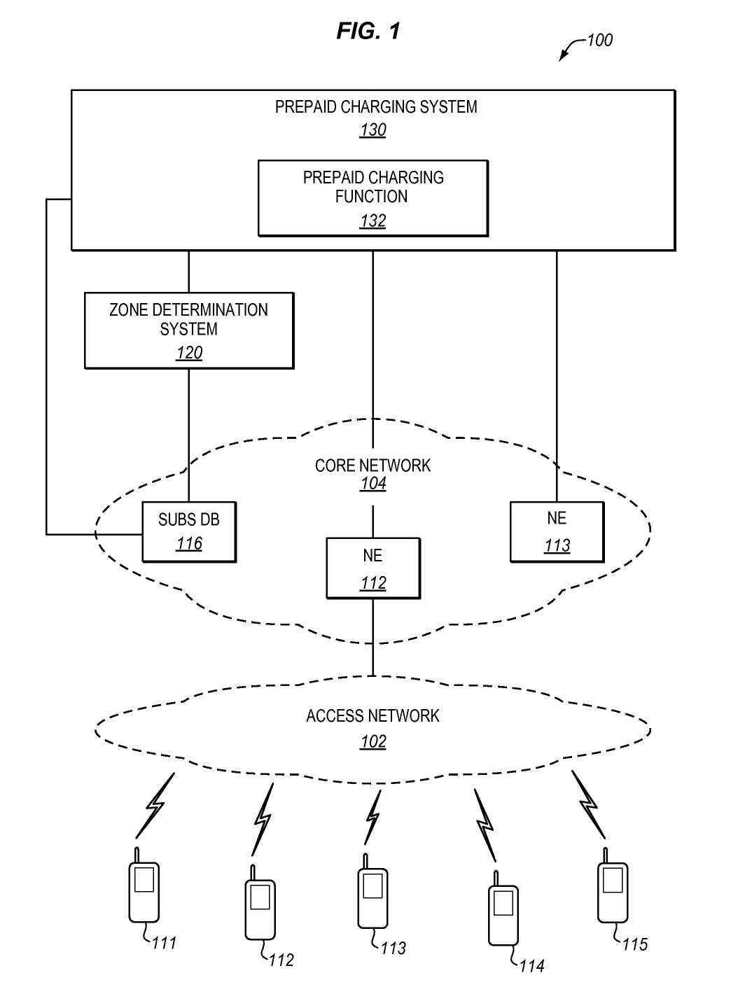

FIGS. 1-5 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes an access network 102, a core network 104, a zone determination system 120, and a prepaid charging system 130. Access network 102 comprises any mobile network operable to communicate with a plurality of mobile devices 111-115 via wireless signals to connect the mobile devices 111-115 to a core network of a service provider. Access network 102 may comprise a UTRAN network, a CDMA network, a GSM network, a UMTS network, a WiFi/WiMAX network, etc. Core network 104 is the central part of communication network 100 that provides various services to mobile devices 111-115. Core network 104 may comprise an IMS network, a legacy network, or another type of network. Core network 104 includes a plurality of network elements (NE) 112-113, and a subscriber database 116. A network element comprises any system, server, or function adapted to provide a service or otherwise serve a session. For example, network elements 112-113 may comprise Serving-Call Session Control Functions (S-CSCF), Application Servers (AS), Break-out Gateway Control Functions (BGCF), Media Gateway Control Functions (MGCF), or any other type of IMS network element. Network elements 112-113 may alternatively comprise Mobile Switching Centers (MSC), Service Control Points (SCP), Short Message Service Centers (SMSC), MultiMedia Service Centers (MMSC), or any other legacy devices. Subscriber database 116 comprises any system, server, or function operable to store and maintain profiles for the users of mobile devices 111-115 and other mobile devices. Subscriber database 116 may comprise a Home Subscriber Server (HSS), a Home Location Register (HLR), or another database.

Zone determination system 120 comprises any system, server, or component operable to monitor location information for one or more of mobile devices 111-115, and determine if one or more of the mobile devices 111-115 changes zones. A zone comprises an area or location defined by a service provider as being distinct from other areas or locations. For example, a service provider may segment a state, a region, or a country into a plurality of distinct zones. The service provider may then define a charging index for each zone. If a subscriber is in a home zone as defined by the service provider, then a lower charging index may be applied. If a subscriber is outside of the home zone, then a higher charging index may be applied.

Prepaid charging system 130 comprises any system, server, or component operable to provide prepaid charging for sessions in communication network 100 and/or other communication networks. Prepaid charging system 130 includes a prepaid charging function 132 that is operable to perform the prepaid charging mechanisms. Although only prepaid charging function 132 is shown, those skilled in the art will appreciate that prepaid charging system 130 may include a rating function, an account balance management function, or other functions used to perform prepaid (or online) charging. Also, although zone determination system 120 is illustrated as a separate, stand-alone system in FIG. 1, zone determination system 120 may alternatively be implemented in one or more systems or servers in core network 104, may be implemented in prepaid charging system 130, or implemented in other 3^{rd} party servers or systems.

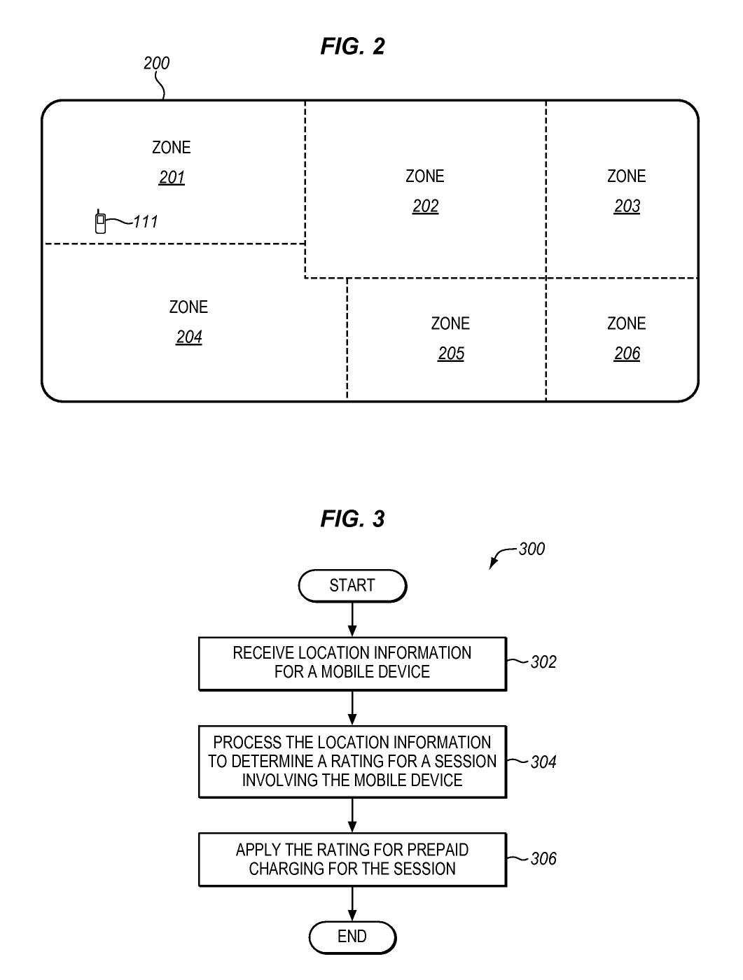

Access network 102 and other access networks connected to core network 104 (if any) make up the service or coverage area for communication network 100. The service provider operating communication network 100 may segment the service area into a plurality of zones. For example, FIG. 2 illustrates a particular area 200 segmented into zones 201-206 in an exemplary embodiment of the invention. Area 200 may represent a state, a region, a country, etc. The service provider assigns a home zone to each of its subscribers. For example, a home zone for the subscriber operating mobile device 111 may be zone 201; while the remaining zones 202-206 are referred to as non-home zones. The subscriber operating mobile device 111 may receive a reduced charging rate for sessions while in his/her home zone, but may receive a higher charging rate for sessions while in a non-home zone. There may be other differences in service also depending on if a subscriber is located in his/her home zone or in a non-home zone.

When in operation, assume that one of the mobile devices (such as mobile device 111) initiates a prepaid session or is invited to a prepaid session (see FIG. 1). Because this is a prepaid session, core network 104 needs to get permission from prepaid charging system 130 before the session can be authorized. Thus, network element 112, which is serving mobile device 111, receives the signaling for the session initiation. Network element 112 includes a Charging Trigger Function (CTF) that detects a charging event, which is the session initiation. The CTF in network element 112 then generates a charging request message that requests authorization for the session and a quota of service units, and transmits the charging request message to prepaid charging system 130. The CTF may transmits the charging request message as a CAP 1/2/3 message in a GSM network, as an IS 826 message in a CDMA network, as a Diameter message in an IMS network, etc. Prepaid charging system 130 then operates as described below in FIG. 3.

FIG. 3 is a flow chart illustrating a method 300 of performing prepaid charging in an exemplary embodiment of the invention. The steps of method 300 will be described with reference to communication network 100 in FIG. 1, although the method may be performed by other types of communication networks. The steps of the flow chart in FIG. 3 are not all inclusive and may include other steps not shown.

In step 302, prepaid charging function 132 receives location information for mobile device 111. Prepaid charging function 132 may receive the location information in a variety of ways. For instance, network element 112 may insert the location information in the charging request message, such as by inserting a cell ID, a sector ID, etc. Alternatively, prepaid charging function 132 may query subscriber database 116 for the subscriber profile associated with mobile device 111, in order to obtain the subscription information for the subscriber. The subscriber profile may also include location information for mobile device 111. Prepaid charging function 132 may also query other location servers or systems to obtain the location information for mobile device 111.

In step 304, prepaid charging function 132 processes the location information to determine a rating for the session. This is an initial rating for the session that is determined upon set up of the session. In step 306, prepaid charging function 132 applies the rating for prepaid charging for the session. In applying the rating, prepaid charging function 132 grants a quota of service units based on the rating and the account balance of the user of mobile device 111. The quota of service units may be an allotment of time, an allotment of monetary units, etc. Prepaid charging function 132 then transmits the granted quota to a budget control system in core network 104. The budget control system may be implemented in one or more of network elements 112-113.

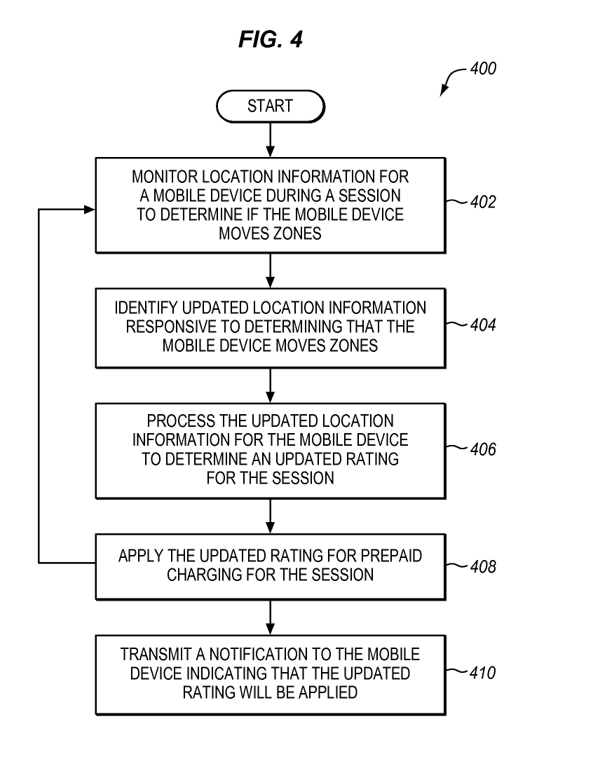

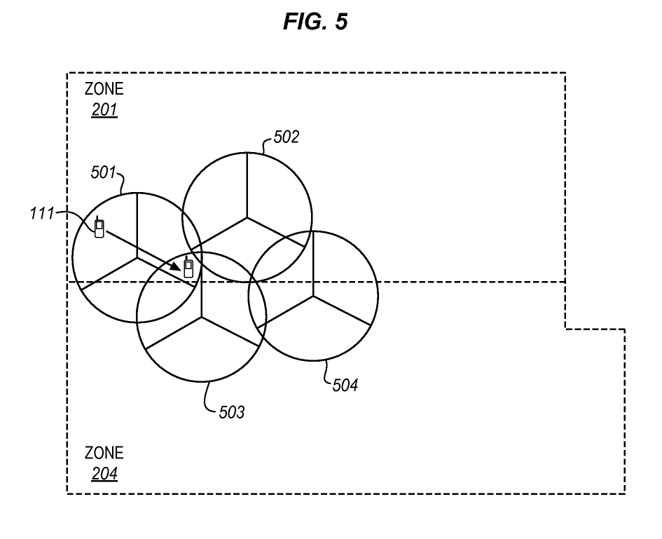

In present prepaid charging systems, the rating which is determined during set up of the session is used throughout the session, and does not change. According to the embodiments herein, the rating may change responsive to a change in location by mobile device 111, as is described in FIG. 4.

FIG. 4 is a flow chart illustrating a method 400 of performing prepaid charging in an exemplary embodiment of the invention. The steps of method 400 will be described with reference to communication network 100 in FIG. 1, although the method may be performed by other types of communication networks. The steps of the flow chart in FIG. 4 are not all inclusive and may include other steps not shown.

In step 402, zone determination system 120 monitors location information for mobile device 111 during the session to determine if mobile device 111 moves from one zone to another zone. For instance, in FIG. 2, mobile device 111 is initially in zone 201. Assume during the session that mobile device 111 moves from zone 201 to zone 202. Zone determination system 120 is able to monitor this movement and determine when mobile device 111 changes zones.

To monitor the location of mobile device 111, zone determination system 120 may periodically query subscriber database 116 to obtain the present cell ID/sector. ID of mobile device 111. For example, if subscriber database 116 comprises an HLR, then zone determination system 120 may periodically transmit a message (e.g., a POSREQ message for a CDMA network, or a MAP ATI message for GSM network) to the HLR to check whether the serving cell for mobile device 111 has changed, and then further determine whether the zone has changed. Zone determination system 120 may alternatively query a location database to obtain the present cell ID/sector ID of mobile device 111. Based on the present location information (e.g., cell ID/sector ID) for mobile device 111, zone determination system 120 is able to determine when mobile device 111 moves zones. Zone determination system 120 may include a list or a data structure indicating how the zones are defined according to cell ID/sector ID. Based on the present cell ID/sector ID, zone determination system 120 is able to determine in which zone the mobile device 111 is presently located. If the present zone of mobile device 111 is different than a previous zone of mobile device 111, then zone determination system 120 is able to detect a change of zones.

Responsive to detecting the change of zones, zone determination system 120 identifies updated location information for mobile device 111 in step 404. The updated location information may comprise a new cell ID/sector ID or another type of update. Zone determination system 120 may then transmit the updated location information to prepaid charging function 132.

In step 406, prepaid charging function 132 processes the updated location information for mobile device 111 to determine an updated or new rating for the session. In step 408, prepaid charging function 132 applies the updated rating for prepaid charging for the session in place of the previous rating. For instance, if prepaid charging function 132 has already granted a quota of service units according to the previous rating, and transmitted the quota to a budget control system in core network 104, then prepaid charging function 132 may first request a return of the remaining or unused quota from the budget control system. Then, prepaid charging function 132 calculates a new quota based on the updated rating, and transmits the new quota to the budget control system. The budget control system may then monitor the quota that was calculated based on the updated rating.

Method 400 may include the optional step 410 of having the prepaid charging function 132 transmit a notification to mobile device 111 indicating that the updated rating will be applied to the session: For instance, the notification may be informing the user of mobile device 111 that a higher rate or a lower rate will be applied to the session to due the movement from zone to zone. Method 400 then returns to step 402, and zone determination system 120 monitors the location information for mobile device 111 to determine if mobile device 111 again moves zones.

Before applying the updated rating for the session, prepaid charging function 132 may process more or more factors in determining when and if the updated rating should be applied instead of the previous rating. The update factors comprise any rules or policies used to define how ratings are dynamically changed during a session. In one embodiment, one of the update factors defining when rating changes should be made is the direction of movement of the mobile device, such as from a home zone to a non-home zone, or from a non-home zone to a home zone. If mobile device 111 moves from a non-home zone to the home zone, then prepaid charging function 132 may apply the updated rating instead of the previous rating. If mobile device 111 moves from the home zone to a non-home zone, then prepaid charging function 132 may additionally or alternatively apply the updated rating instead of the previous rating.

In another embodiment, another factor defining when rating changes should be made is how long the mobile device remains in the new zone. This factor avoids making a rating change during the session when a mobile device makes small movements near a boundary of a zone. When taking this factor into consideration, prepaid charging function 132 sets a timer responsive to receiving the updated location information. Zone determination system 120 determines new updated information for mobile device 111 responsive to expiration of the timer in prepaid charging function 132. Prepaid charging function 132 then processes the new updated information to determine if mobile device 111 remains in the new zone. If mobile device 111 remains in the new zone, then prepaid charging function 132 applies the updated rating for the session. If mobile device 111 returns to the previous zone, then prepaid charging function 132 continues to apply the previous rating, and no change to the rating is made.

In another embodiment, another factor defining when rating changes should be made is if the new zone borders or is directly adjacent to the previous zone. In the real mobile network deployment, the coverage area of cells (or base stations) may have some degree overlap. Several cells may cover this area at the same time. FIG. 5 illustrates cells within two zones 201 and 204 in an exemplary embodiment of the invention. Once again, zone 201 is the home zone for mobile device 111. Cells 501-502 primarily serve zone 201, while cells 503-504 primarily serve zone 204. When mobile device 111 moves from cell 501 to the common coverage area of cell 501 and cell 503, the serving cell may remain as cell 501 or may switch to the neighboring cell 503. If the serving cell changes to cell 503 which belongs to a different zone, as is the case in FIG. 5, then mobile device 111 has changed zones.

Prepaid charging function 132 may wait to dynamically update the rating for the session, or reject updating the rating all together if mobile device 111 moves to a boundary zone or a neighboring zone. Because a move from a home zone 201 to a boundary zone 204 may comprise a small movement (see FIG. 5), such as less than a mile, prepaid charging function 132 may determine that an change to a rating may not be desirable, as mobile device 111 may quickly return to home zone 201. Prepaid charging function 132 may also measure the time that mobile device 111 is in the boundary zone 204 as described above, and then update the rating for the session after a threshold time period.

Prepaid charging function 132 and zone determination system 120 as shown in FIG. 1 may also implement a heart beat mechanism. Zone determination system 120 may periodically check whether prepaid charging function 132 is operating correctly. If zone determination system 120 determines that prepaid charging function 132 has failed due to whatever reasons, then zone determination system 120 suspends the monitoring of the location of mobile device 111. That way, zone determination system 120 will not blindly trace the location of mobile device 111 when charging for the session has failed.

Although specific embodiments were described herein, the scope of the invention is not limited to those specific embodiments. The scope of the invention is defined by the following claims and any equivalents thereof.

We claim:

1. A communication network, comprising:
a prepaid charging function operable to receive location information for a mobile device located in a first zone, to process the location information to determine a rating for a session involving the mobile device, and to apply the rating for prepaid charging for the session; and
a zone determination system operable to monitor the location information for the mobile device during the session to determine if the mobile device moves from the first zone to a second zone, to identify updated location information for the mobile device responsive to a determination that the mobile device has moved from the first zone to the second zone, and to transmit the updated location information to the prepaid charging function;
the prepaid charging function is further operable to process the updated location information for the mobile device to determine an updated rating the session, and to apply the updated rating for prepaid charging for the session.

2. The communication network of claim 1 wherein the prepaid charging function is further operable to:
determine if the mobile device moves from a non-home zone to a home zone; and
apply the updated rating if the mobile device moves from the non-home zone to the home zone.

3. The communication network of claim 1 wherein the prepaid charging function is further operable to:
determine if the mobile device moves from a home zone to a non-home zone; and
apply the updated rating if the mobile device moves from the home zone to the non-home zone.

4. The communication network of claim 1 wherein:
the prepaid charging function is further operable to set a timer responsive to receiving the updated location information;
the zone determination system is further operable to determine new updated location information for the mobile device responsive to expiration of the timer in the prepaid charging function; and
the prepaid charging function is further operable to process the new updated location information to determine if the mobile device remains in the second zone, and to apply the updated rating if the mobile device remains in the second zone.

5. The communication network of claim 1 wherein the prepaid charging function is further operable to:
apply the updated rating if the second zone is not a boundary zone to the first zone.

6. The communication network of claim 1 wherein the zone determination system is further operable to:
periodically query a subscriber database for the location information for the mobile device.

7. The communication network of claim 1 wherein the prepaid charging function is further operable to:
transmit a notification to the mobile device indicating that the updated rating will be applied to the session.

8. The communication network of claim 1 wherein if the prepaid charging function has granted a quota of service units according to the rating to a budget control system, then prepaid charging function is further operable to:
request a return of the unused quota from the budget control system;
calculate a new quota based on the updated rating; and
transmit the new quota to the budget control system.

9. A method of dynamically changing the rating for prepaid sessions, the method comprising:
receiving location information for a mobile device located in a first zone;
processing the location information to determine a rating for a session involving the mobile device;
applying the rating for prepaid charging for the session;
monitoring the location information for the mobile device during the session to determine if the mobile device moves from the first zone to a second zone;
identifying updated location information for the mobile device responsive to a determination that the mobile device has moved from the first zone to the second zone;
processing the updated location information for the mobile device to determine an updated rating the session; and
applying the updated rating for prepaid charging for the session.

10. The method of claim 9 wherein applying the updated rating for prepaid charging comprises:
determining if the mobile device moves from a non-home zone to a home zone; and
applying the updated rating if the mobile device moves from the non-home zone to the home zone.

11. The method of claim 9 wherein applying the updated rating for prepaid charging comprises:
determining if the mobile device moves from a home zone to a non-home zone; and
applying the updated rating if the mobile device moves from the home zone to the non-home zone.

12. The method of claim 9 wherein applying the updated rating for prepaid charging comprises:
setting a timer;
determining new updated location information for the mobile device responsive to expiration of the timer;
processing the new updated location information to determine if the mobile device remains in the second zone; and
applying the updated rating if the mobile device remains in the second zone.

13. The method of claim 9 wherein applying the updated rating for prepaid charging comprises:
applying the updated rating if the second zone is not a boundary zone to the first zone.

14. The method of claim 9 wherein monitoring the location information for the mobile device during the session comprises:
periodically querying a subscriber database for the location information for the mobile device.

15. The method of claim 9 further comprising:
transmitting a notification to the mobile device indicating that the updated rating will be applied to the session.

16. The method of claim 9 wherein if a quota of service units has been granted to a budget control system, then the method further comprises:
requesting a return of the unused quota from the budget control system;
calculating a new quota based on the updated rating; and
transmitting the new quota to the budget control system.

17. A method of dynamically changing the rating for a prepaid session involving a mobile device, wherein an initial rating is defined for the session during set up, the method comprising:
identifying updated location information for the mobile device during the session responsive to a determination that the mobile device has moved from one location to another;
processing the updated location information for the mobile device to determine an updated rating the session; and
applying the updated rating for prepaid charging for the session instead of the initial rating.

18. The method of claim 17 further comprising:
monitoring the location information for the mobile device during the session to determine if the mobile device moves from one zone to another zone; and
identify the updated location information responsive to a determination that the mobile device has moved from one zone to another zone.

19. The method of claim 17 wherein applying the updated rating for prepaid charging comprises:
setting a timer;
determining new updated location information for the mobile device responsive to expiration of the timer;
processing the new updated location information to determine if the mobile device remains in the other zone; and
applying the updated rating if the mobile device remains in the other zone.

20. The method of claim 17 further comprising:
transmitting a notification to the mobile device indicating that the updated rating will be applied to the session.

21. A prepaid charging system, comprising:
a prepaid charging function operable to receive location information for a mobile device located in a first zone, to process the location information to determine a rating for a session involving the mobile device, and to apply the rating for prepaid charging for the session; and
the prepaid charging function is further operable to identify updated location information for the mobile device, to process the updated location information to determine an updated rating the session, and to apply the updated rating for prepaid charging for the session.
